(19) United States
(12) Patent Application Publication
(10) Pub. No.: US 2019/0143993 A1
(43) Pub. Date: May 16, 2019

(54) DISTRACTED DRIVING DETERMINATION APPARATUS, DISTRACTED DRIVING DETERMINATION METHOD, AND PROGRAM

(71) Applicant: OMRON Corporation, Kyoto-shi (JP)

(72) Inventors: Hatsumi AOI, Kyotanabe-shi (JP); Tomoyoshi AIZAWA, Kyoto-shi (JP); Tadashi HYUGA, Hirakata-shi (JP); Yoshio MATSUURA, Kasugai-shi (JP); Masato TANAKA, Kizugawa-shi (JP); Keisuke YOKOTA, Kasugai-shi (JP); Hisashi SAITO, Kasugai-shi (JP)

(73) Assignee: OMRON Corporation, Kyoto-shi (JP)

(21) Appl. No.: 16/143,459

(22) Filed: Sep. 27, 2018

(30) Foreign Application Priority Data
Nov. 15, 2017 (JP) 2017-219858

(51) Int. Cl. B60W 40/09; G06K 9/00; B60W 40/076; G06F 3/01

(52) U.S. Cl. CPC B60W 40/09; G06F 3/012; B60W 40/076; G06K 9/00845

(57) ABSTRACT

On a vehicle traveling on a downward slope, a driver's intentional checking is erroneously determined to be distracted driving, thus generating an alert. An apparatus includes an image data obtaining unit that obtains image data about a driver, a distracted driving determiner that determines distracted driving based on a face orientation and gaze of the driver captured in the image data and a determination criterion, a traveling state obtaining unit that obtains traveling state data about the vehicle, a traveling state determiner that determines whether the vehicle is traveling downward based on the traveling state data, and a criterion changer that changes, when the vehicle is determined to be traveling downward, the determination criterion for an upward face orientation and the gaze of the driver from a value used when the vehicle is determined not to be traveling downward.

### CROSS-REFERENCE TO RELATED APPLICATION

This application claims priority to Japanese Patent Application No. 2017-219858 filed on Nov. 15, 2017, the entire disclosure of which is incorporated herein by reference.

### FIELD

The present invention relates to a distracted driving determination apparatus, a distracted driving determination method, and a program for determining distracted driving of a vehicle driver.

### BACKGROUND

A known technique for a vehicle determines distracted driving of a vehicle driver (hereafter, simply a driver) in the lateral direction based on his or her face orientation or gaze using an image of the driver captured during driving with, for example, an on-board camera, and alerts the driver in a timely manner.

This type of technique determines distracted driving of a driver based on a determination criterion that is changeable depending on the driving state of the vehicle. Patent literature 1 (Japanese Unexamined Patent Application Publication No. 2001-138767) uses an allowable duration as one such criterion.

For example, the allowable duration is set shorter when the vehicle is traveling at a speed higher than a predetermined speed, or at a distance shorter than a predetermined distance from a vehicle traveling ahead. This increases the likelihood that distracted driving is detected, thus generating an alert to the driver in a reliable manner.

### SUMMARY

### Technical Problem

However, such known determination criteria that are changeable may have issues described below.

When driving the vehicle on a straight downward slope, for example, a driver experiencing a higher vehicle speed toward an end of the slope may look farther in the traveling direction beyond the end of the downward slope. Thus, the driver may look up with respect to the traveling direction for a longer duration. However, the above technique described in, for example, Patent Literature 1, uses a shorter allowable duration set for the vehicle traveling on the straight downward slope at a higher speed.

The driver's action of intentionally checking farther in the traveling direction beyond the end of the slope while the vehicle is traveling on the straight downward slope, or specifically the driver's action of looking up may be erroneously determined to be distracted driving, thus generating an alert to the driver.

One or more aspects of the present invention are directed to a distracted driving determination apparatus, a distracted driving determination method, and a program that prevent the driver's action of looking up from being erroneously determined to be distracted driving while the vehicle is traveling downward.

### Solution to Problem

In response to the above issue, the aspects of the present invention may be implemented in the manner described below.

A distracted driving determination apparatus for determining distracted driving of a driver of a vehicle according to a first aspect of the present invention includes an image data obtaining unit that obtains image data about the driver from an imaging unit mounted on the vehicle, a distracted driving determiner that determines distracted driving of the driver based on a face orientation and a gaze of the driver captured in the image data and a determination criterion for detecting distracted driving of the driver, a traveling state obtaining unit that obtains traveling state data about the vehicle from a traveling state obtaining member mounted on the vehicle, a traveling state determiner that determines whether the vehicle is traveling downward based on the obtained traveling state data, and a criterion changer that changes, when the vehicle is determined to be traveling downward, the determination criterion for an upward face orientation and the gaze of the driver from a value used when the vehicle is determined not to be traveling downward.

A distracted driving determination apparatus according to a second aspect of the present invention is the distracted driving determination apparatus according to the first aspect in which the determination criterion includes a position and a dimension of a non-distracted driving area in which a gaze direction of the driver is allowed to reside without causing detection of distracted driving, and an allowable residence duration for which the gaze direction of the driver is allowed to reside within a distracted driving area outside the non-distracted driving area without causing detection of distracted driving.

A distracted driving determination apparatus according to a third aspect of the present invention is the distracted driving determination apparatus according to the second aspect in which the criterion changer changes the determination criterion at least by extending the allowable residence duration or by enlarging the dimension or shifting the position of the non-distracted driving area upward with respect to a traveling direction of the vehicle.

A distracted driving determination apparatus according to a fourth aspect of the present invention is the distracted driving determination apparatus according to the second aspect in which the determination criterion includes a plurality of the distracted driving areas and a value of the allowable residence duration for each of the distracted driving areas set in accordance with closeness to the non-distracted driving area.

A distracted driving determination apparatus according to a fifth aspect of the present invention is the distracted driving determination apparatus according to the fourth aspect in which the allowable residence duration is set longer for a distracted driving area closer to the non-distracted driving area among the plurality of distracted driving areas.

A distracted driving determination apparatus according to a sixth aspect of the present invention is the distracted driving determination apparatus according to the first aspect in which the traveling state obtaining member includes an inclination angle sensor mounted on the vehicle, and the traveling state data includes inclination angle data about the vehicle obtained by the inclination angle sensor with respect to a horizontal plane.

A distracted driving determination apparatus according to a seventh aspect of the present invention is the distracted driving determination apparatus according to the first aspect in which the traveling state determiner includes a positioning sensor mounted on the vehicle, the traveling state data includes traveling location data about the vehicle obtained by the positioning sensor, and the traveling state determiner determines whether the vehicle is traveling downward based on the traveling location data and map data.

A distracted driving determination apparatus according to an eighth aspect of the present invention is the distracted driving determination apparatus according to the first aspect further including an alert control unit that controls an alert generator to generate an alert when the distracted driving determiner detects distracted driving.

A distracted driving determination method according to a ninth aspect of the present invention performed by an apparatus for determining distracted driving of a driver of a vehicle includes obtaining, with the apparatus, image data about the driver from an imaging unit mounted on the vehicle, determining, with the apparatus, distracted driving of the driver based on a face orientation and a gaze of the driver captured in the image data and a determination criterion for detecting distracted driving of the driver, obtaining, with the apparatus, traveling state data about the vehicle from a traveling state obtaining member mounted on the vehicle, determining, with the apparatus, whether the vehicle is traveling downward based on the traveling state data, and changing, with the apparatus when the vehicle is determined to be traveling downward, the determination criterion for an upward face orientation and the gaze of the driver from a value used when the vehicle is determined not to be traveling downward.

A program for determining distracted driving according to a tenth aspect of the present invention causes a computer to implement processes performed by the units included in the distracted driving determination apparatus according to any one of the first to eighth aspects.

### Advantageous Effects

The apparatus, method, and program according to the first, ninth, and tenth aspects of the invention can change the determination criterion for an upward face orientation and gaze of the driver from a value used when the vehicle is not traveling downward to reflect specific situations in which the driver intentionally looks up with respect to the traveling direction for a longer duration when the vehicle is traveling downward, and determine distracted driving based on the changed determination criterion and image data about the driver. As described above, the determination criterion is changed to appropriately reflect the specific situations of the vehicle traveling downward. This lowers the likelihood that distracted driving is erroneously detected while the vehicle is traveling downward.

The apparatus according to the second aspect can specifically define the determination criterion using the position or dimension of the non-distracted driving area and the allowable residence duration for the distracted driving area.

The apparatus according to the third aspect can change the determination criterion at least by extending the allowable residence duration or by enlarging the dimension or shifting the position of the non-distracted driving area upward with respect to the traveling direction of the vehicle.

The apparatus according to the fourth aspect can define the determination criterion appropriately by setting the allowable residence duration for each distracted driving area in accordance with its closeness to the non-distracted driving area.

The apparatus according to the fifth aspect can define the determination criterion appropriately by setting the allowable residence duration longer for the distracted driving area closer to the non-distracted driving area.

The apparatus according to the sixth aspect can obtain the inclination angle data about the vehicle with respect to the horizontal plane using the inclination angle sensor, and can thus determine whether the vehicle is traveling downward based on the inclination angle data.

The apparatus according to the seventh aspect can obtain the traveling location data about the vehicle using the positioning sensor, and determine whether the vehicle is traveling downward based on the traveling location data and map data.

The apparatus according to the eighth aspect can generate an alert from the alert generator when the driver is determined to be engaging in distracted driving. This structure alerts the driver to distracted driving.

### BRIEF DESCRIPTION OF THE DRAWINGS

FIG. 1 is a schematic diagram of a vehicle including a distracted driving determination apparatus according to a first embodiment.

FIG. 2 is a functional block diagram of the distracted driving determination apparatus according to the first embodiment.

FIG. 3 is a schematic diagram describing an example determination criterion.

FIG. 4 is a horizontal diagram of an example road including a downward slope.

FIG. 5 is a schematic diagram describing an example of a relaxed determination criterion.

FIG. 6 is a flowchart showing an example operation performed by the distracted driving determination apparatus according to the first embodiment.

FIG. 7 is a schematic diagram of a vehicle including a distracted driving determination apparatus according to a second embodiment showing its example structure.

FIG. 8 is a functional block diagram of the distracted driving determination apparatus according to the second embodiment.

FIG. 9 is a horizontal diagram of another example road including a downward slope.

FIG. 10 is a flowchart showing an example operation performed by the distracted driving determination apparatus according to the second embodiment.

### DETAILED DESCRIPTION

Embodiments of the present invention will be described below with reference to the drawings.

### Example

### Structure

A distracted driving determination apparatus implementing a distracted driving determination method according to one or more embodiments of the present invention will now be described with reference to the drawings.

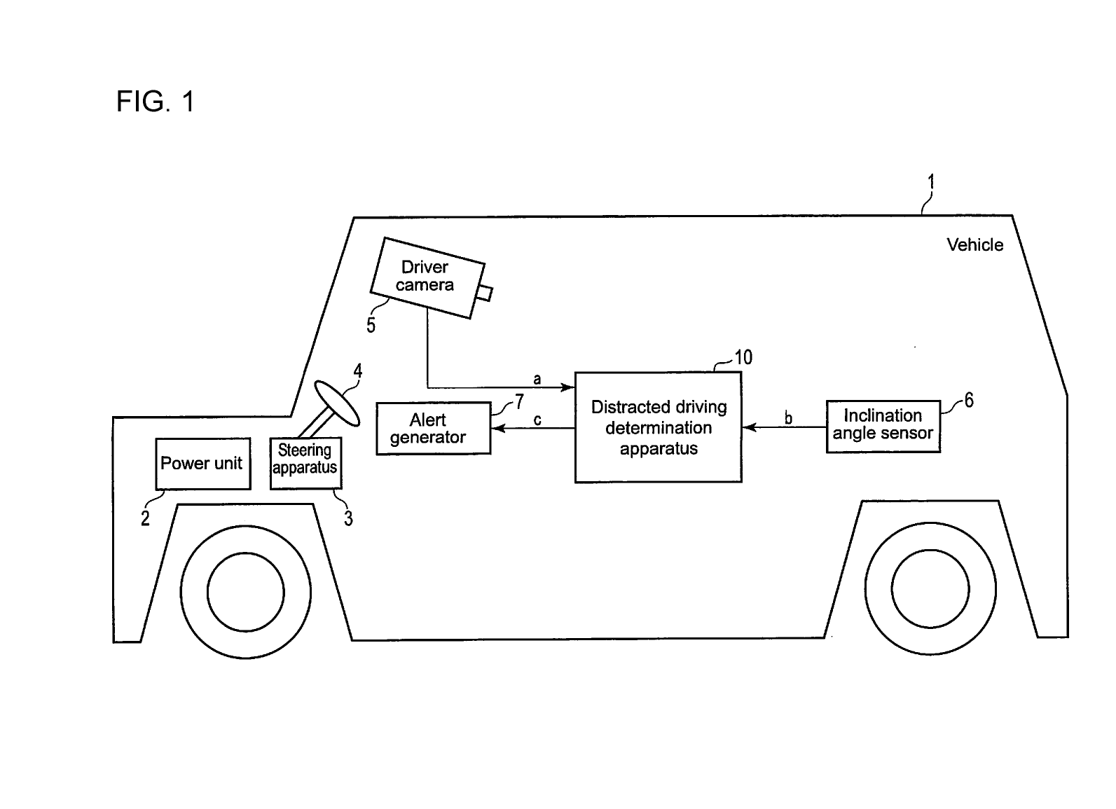

FIG. 1 is a schematic diagram of a vehicle 1 including a distracted driving determination apparatus 10 according to a first embodiment.

The vehicle 1 typically includes, as its basic components, a power unit 2 including a power supply and a speed changer, and a steering apparatus 3 incorporating a steering wheel 4. The vehicle 1 further includes a transmission for transmitting power generated by the power unit 2 to the wheels, a controller for controlling driving, and various sensors used for controlling the controller. To simplify the drawing, FIG. 1 does not show these components, and simply shows the distracted driving determination apparatus 10 and components associated with the distracted driving determination apparatus 10, including a driver camera 5, an inclination angle sensor 6, and an alert generator 7.

The driver camera 5 is mounted on the vehicle 1 in front of a driver on, for example, the instrument panel. The driver camera 5 captures an image of the driver, and outputs an image data signal a to the distracted driving determination apparatus 10. The driver camera 5 may start capturing images in response to a request from the distracted driving determination apparatus 10 or may constantly capture such images during the operation of the vehicle 1.

The inclination angle sensor 6 is mounted on the vehicle 1 to measure the inclination angle of the vehicle 1 with respect to a horizontal plane. The inclination angle sensor 6 outputs an inclination angle data signal b indicating the measurement result to the distracted driving determination apparatus 10. For example, the inclination angle sensor 6 outputs an inclination angle data signal b indicating a positive value when the vehicle 1 is traveling on an upward slope, an inclination angle data signal b indicating a negative value when the vehicle 1 is traveling on a downward slope, and an inclination angle data signal b indicating zero when the vehicle 1 is traveling along a horizontal plane.

The distracted driving determination apparatus 10 determines distracted driving of the driver based on the face orientation and gaze of the driver obtained from the image data signal a and a determination criterion for detecting distracted driving. When the vehicle 1 is determined to be traveling downward based on the inclination angle data signal b, the distracted driving determination apparatus 10 changes the determination criterion for an upward face orientation and gaze of the driver from a value used when the vehicle 1 is not traveling downward. When detecting distracted driving, the distracted driving determination apparatus 10 outputs an instruction signal c.

The alert generator 7 is installed in the vehicle 1, and generates an alert in response to the instruction signal c from the distracted driving determination apparatus 10. Examples of an alert include, in addition to a buzzer sound, a display, light emission, vibrations, and communication to mobile terminals.

### Advantages and Effects

The distracted driving determination apparatus 10 with this structure detects the driver's distracted driving during driving of the vehicle 1, and generates an alert. When the vehicle 1 is traveling downward, the distracted driving determination apparatus 10 changes the determination criterion for an upward face orientation and gaze of the driver from a value used when the vehicle 1 is not traveling downward. The distracted driving determination apparatus 10 can determine distracted driving based on the changed determination criterion and image data about the driver.

When the vehicle 1 is traveling downward, the driver may intentionally look up for a longer duration. The distracted driving determination apparatus 10 changes the determination criterion appropriately to reflect such specific situations, and can thus lower the likelihood that distracted driving is erroneously detected when the vehicle 1 is traveling downward.

### First Embodiment

The distracted driving determination apparatus 10 according to a first embodiment will now be described in detail.

### Example Structure

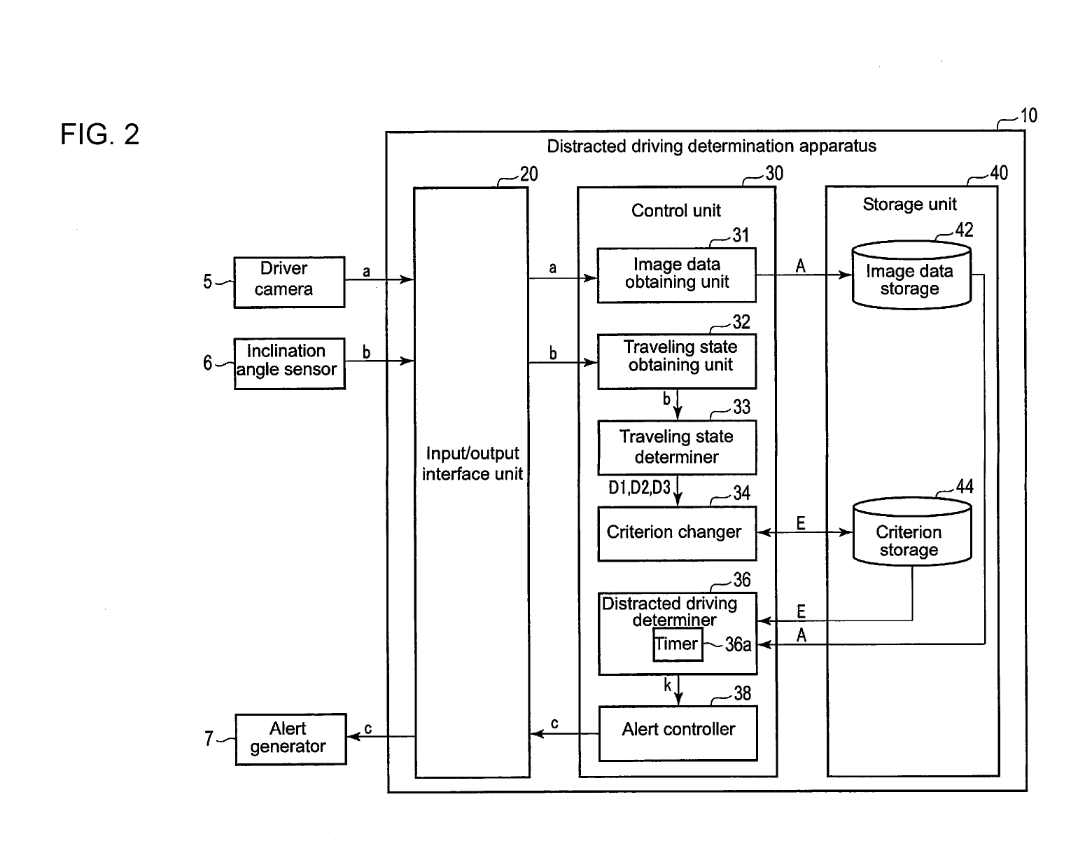

FIG. 2 is a functional block diagram of the distracted driving determination apparatus 10 according to the present embodiment.

The distracted driving determination apparatus 10 controls the alert generator 7 to generate an alert when detecting distracted driving of the driver. The distracted driving determination apparatus 10 includes an input/output interface unit 20, a control unit 30, and a storage unit 40.

The input/output interface unit 20 receives the image data signal a output from the driver camera 5, and outputs the signal to the control unit 30. The input/output interface unit 20 receives the inclination angle data signal b output from the inclination angle sensor 6, and outputs the signal to the control unit 30. Further, the input/output interface unit 20 outputs the instruction signal c output from the control unit 30 to the alert generator 7.

The storage unit 40 uses a nonvolatile memory as a storage medium, such as a solid state drive (SSD) or a hard disk drive (HDD), which is writable and readable as appropriate. The storage unit 40 includes, as storage areas according to the present embodiment, an image data storage 42 and a criterion storage 44.

The control unit 30 includes a central processing unit (CPU) included in a computer, and a program memory. The control unit 30 includes, as control functions according to the present embodiment, an image data obtaining unit 31, a traveling state obtaining unit 32, a traveling state determiner 33, a criterion changer 34, a distracted driving determiner 36, and an alert controller 38. These control functions are implemented by the CPU executing a program stored in the program memory.

The image data obtaining unit 31 receives image data signals a output from the input/output interface unit 20, and stores the signals into the image data storage 42 as image data A. Thus, the image data storage 42 stores the image data A representing the state of the driver.

The traveling state obtaining unit 32 receives inclination angle data signals b output from the input/output interface unit 20, and outputs the signals to the traveling state determiner 33.

When receiving an inclination angle data signal b indicating a negative value from the traveling state obtaining unit 32, the traveling state determiner 33 determines that the vehicle 1 is traveling downward, and outputs a determination result signal D1 to the criterion changer 34. When receiving the inclination angle data signal b indicating a positive value, the traveling state determiner 33 determines that the vehicle 1 is traveling upward and outputs a determination result signal D2 to the criterion changer 34. When receiving an inclination angle data signal b indicating zero, the traveling state determiner 33 determines that the vehicle 1 is traveling along the horizontal plane, and outputs a determination result signal D3 to the criterion changer 34. In some embodiments, the traveling state determiner 33 may not output the determination result signals D2 and D3.

When receiving a determination result signal D1 from the traveling state determiner 33, or when the vehicle 1 is traveling downward, the criterion changer 34 changes, for an upward face orientation and gaze of the driver, a determination criterion E stored in the criterion storage 44 from a value used when the vehicle 1 is not traveling downward. When receiving a determination result signal D2 or D3 or receiving no output from the traveling state determiner 33, the criterion changer 34 does not change the determination criterion E stored in the criterion storage 44.

A specific process for changing the determination criterion E for an upward face orientation and gaze of the driver will now be described. During downward traveling of the vehicle 1, the determination criterion E is changed from a value used when the vehicle 1 is not traveling downward.

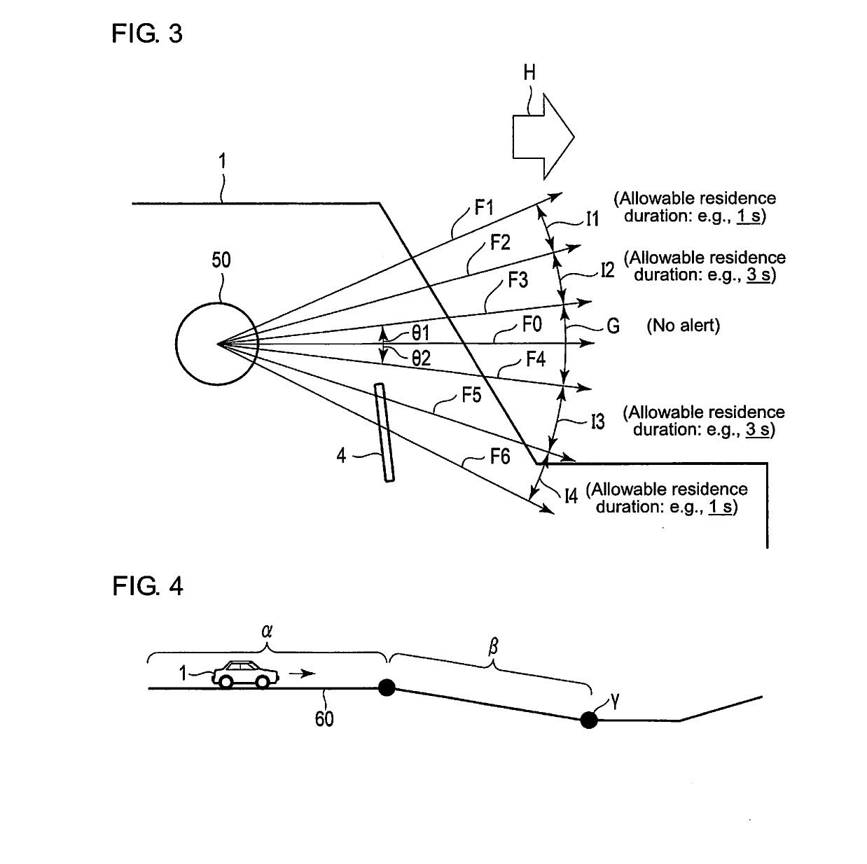

FIG. 3 is a schematic diagram describing an example of the determination criterion E.

When the vehicle 1 is traveling in a traveling direction H (or forward), a gaze direction F of the driver 50 is typically parallel to the traveling direction H or points straight ahead in a gaze direction F0. In this usual driving state, the gaze direction F includes a non-distracted driving area G, which is independent of distracted driving determination and is dedicated to checking for other vehicles or signs in front. The non-distracted driving area G includes the gaze direction F0 in the middle between gaze directions F3 and F4 in the vertical direction. When the gaze direction F resides within the non-distracted driving area G, the driver is determined not to be engaging in distracted driving.

The non-distracted driving area G including the gaze direction F0 in the middle is defined using the total of an angle 81, which is an upper limit angle from the gaze direction F0 to the gaze direction F3, and an angle 82, which is a lower limit angle from the gaze direction F0 to the gaze direction F4. In the present embodiment, the upper limit angle θ1 and the lower limit angle θ2 may be set to predetermined values. This determines the position and the dimension of the non-distracted driving area G in the vertical direction.

A distracted driving area I is defined outside the non-distracted driving area G. Although all areas outside the non-distracted driving area G may form one distracted driving area I, multiple distracted driving areas I may be defined in accordance with their closeness to the non-distracted driving area G. FIG. 3 shows one such example of the distracted driving area I including four distracted driving areas I1, I2, I3, and I4. The distracted driving area I2 is adjacent to and upward from the non-distracted driving area G, and is between the gaze direction F3 and a gaze direction F2. The distracted driving area I3 is adjacent to and downward from the non-distracted driving area G, and is between the gaze direction F4 and a gaze direction F5. The distracted driving area I1 is adjacent to and upward from the distracted driving area I2, and is between the gaze direction F2 and a gaze direction F1. The distracted driving area I4 is adjacent to and downward from the distracted driving area I3, and is between the gaze direction F5 and a gaze direction F6.

The determination criterion E includes an allowable residence duration, which is a duration of time for which distracted driving is not detected although the gaze direction F resides within the distracted driving area I, and the position or the dimension of the non-distracted driving area G. The allowable residence duration is set for each distracted driving area I (e.g., each of the distracted driving areas I1, I2, I3, and I4).

With the determination criterion E described above, distracted driving is detected when the gaze direction F of the driver 50 resides within the same distracted driving area I for a duration longer than the allowable residence duration. Distracted driving is not detected when the gaze direction F residing within the distracted driving area I shifts to another area (e.g., another distracted driving area I or to the non-distracted driving area G) before the allowable residence duration passes.

FIG. 3 also shows the allowable residence duration set for each of the distracted driving areas I1 to I4. Each distracted driving area I closer to the non-distracted driving area G, such as the distracted driving areas I2 and I3, has a relatively long allowable residence duration (e.g., 3 seconds). Each distracted driving area I less close to the non-distracted driving area G, such as the distracted driving areas I1 and I4, has a relatively short allowable residence duration (e.g., 1 second). As described above, defining the multiple distracted driving areas I and setting the allowable residence duration appropriately for each distracted driving area I in accordance with its closeness to the non-distracted driving area G defines the determination criterion E both more precisely and more practically.

When receiving the determination result signal D1 from the traveling state determiner 33, the criterion changer 34 may change the determination criterion E by extending the allowable residence duration set for the distracted driving area I, enlarging the non-distracted driving area G upward, or changing the position of the non-distracted driving area G upward without changing the dimension. For an upward face orientation and gaze of the driver 50, the determination criterion E for the distracted driving area I adjacent to and upward from the non-distracted driving area G is changed from a value used when the vehicle 1 is not traveling downward. This will be described in detail with reference to FIG. 4.

FIG. 4 is a horizontal diagram showing an example of a road 60 including a downward slope.

The vehicle 1 on the road 60 travels, from left to right in FIG. 4, parallel to the horizontal plane in an area α and travels on the downward slope in an area β. Thus, when the vehicle 1 is traveling in the area α, the traveling state determiner 33 outputs either the determination result signal D3 or no signal to the criterion changer 34. When the vehicle 1 enters the area β from the area α and travels downward, the traveling state determiner 33 outputs the determination result signal D1 to the criterion changer 34.

When the vehicle 1 is traveling on a straight downward slope as in the area β, the driver 50 may look forward in the traveling direction beyond a point γ representing the end point γ of the downward slope as approaching the point γ. Thus, the driver 50 intentionally looks up with respect to the traveling direction for a longer duration. To reflect the specific situations of the vehicle traveling downward, the distracted driving determination apparatus 10 according to the present embodiment relaxes the determination criterion E for an upward face orientation and gaze of the driver 50 using the criterion changer 34.

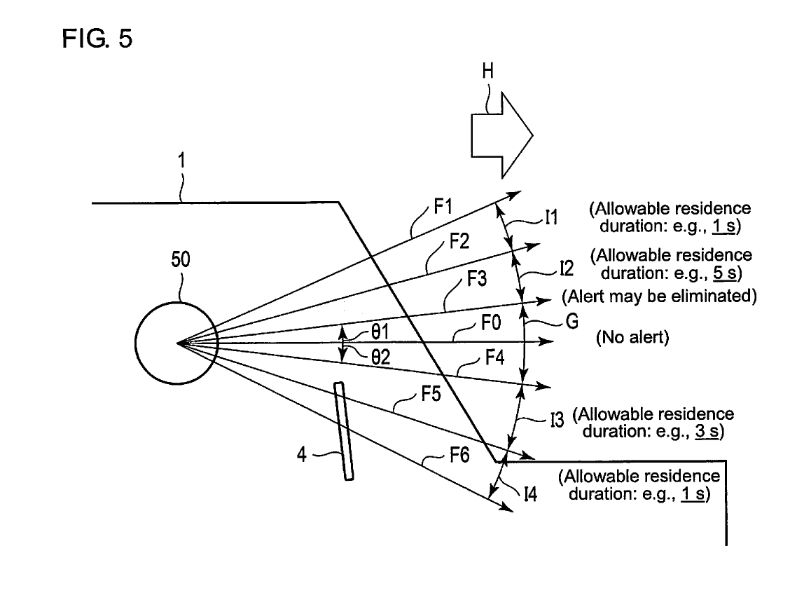

As shown schematically in FIG. 5 describing examples of the relaxed determination criterion, the criterion changer 34 extends the allowable residence duration set for the distracted driving area I2, which is upward from the non-distracted driving area G, longer than a current value (for example, from 3 seconds to 5 seconds). In some embodiments, the distracted driving area I2 may include no allowable residence duration, and may be used in the same manner as the non-distracted driving area G. This equates to enlarging the non-distracted driving area G upward. Enlarging the non-distracted driving area G is not limited to handling the entire distracted driving area I2 in the same manner as the non-distracted driving area G, and may include enlarging the non-distracted driving area G upward and thus handling only a part of the distracted driving area I2 in the same manner as the non-distracted driving area G.

Thus, when the vehicle 1 is traveling downward, the criterion changer 34 relaxes, for an upward face orientation and gaze of the driver 50, the determination criterion E from a value used when the vehicle 1 is not traveling downward. This updates the determination criterion E stored in the criterion storage 44. The criterion changer 34 does not change the determination criterion E when the vehicle 1 is not traveling on a downward slope.

The distracted driving determiner 36 obtains the image data A from the image data storage 42 and the determination criterion E from the criterion storage 44, and determines distracted driving of the driver 50 based on the image data A and the determination criterion E. More specifically, the distracted driving determiner 36 determines whether the gaze direction F of the driver 50, which is obtained from the face orientation or gaze of the driver 50 captured in the image data A, resides within the non-distracted driving area G. When determining that the gaze direction F resides within the non-distracted driving area G, the distracted driving determiner 36 detects no distracted driving.

When determining that the gaze direction F does not reside within the non-distracted driving area G and resides within the distracted driving area I, the distracted driving determiner 36 activates a built-in timer 36a to measure a duration for which the gaze direction F continuously resides in the distracted driving area I. The distracted driving determiner 36 determines whether the measured value has reached the allowable residence duration set for the distracted driving area I.

When the gaze direction F shifts from the distracted driving area I to another area (e.g., another distracted driving area I or the non-distracted driving area G) before the measured value reaches the allowable residence duration, the distracted driving determiner 36 stops the timer 36a, resets the measured value, and detects no distracted driving.

When the measured value by the timer 36a has reached the allowable residence duration, the distracted driving determiner 36 detects distracted driving, and outputs a determination signal k to the alert controller 38.

When receiving the determination signal k from the distracted driving determiner 36, the alert controller 38 outputs the instruction signal c to the input/output interface unit 20. The input/output interface unit 20 outputs the instruction signal c to the alert generator 7.

The alert generator 7 generates an alert in response to the instruction signal c output from the input/output interface unit 20. Examples of an alert include, in addition to a buzzer sound, a display, light emission, vibrations, and communication to mobile terminals. This structure alerts the driver 50 to distracted driving.

### Operation

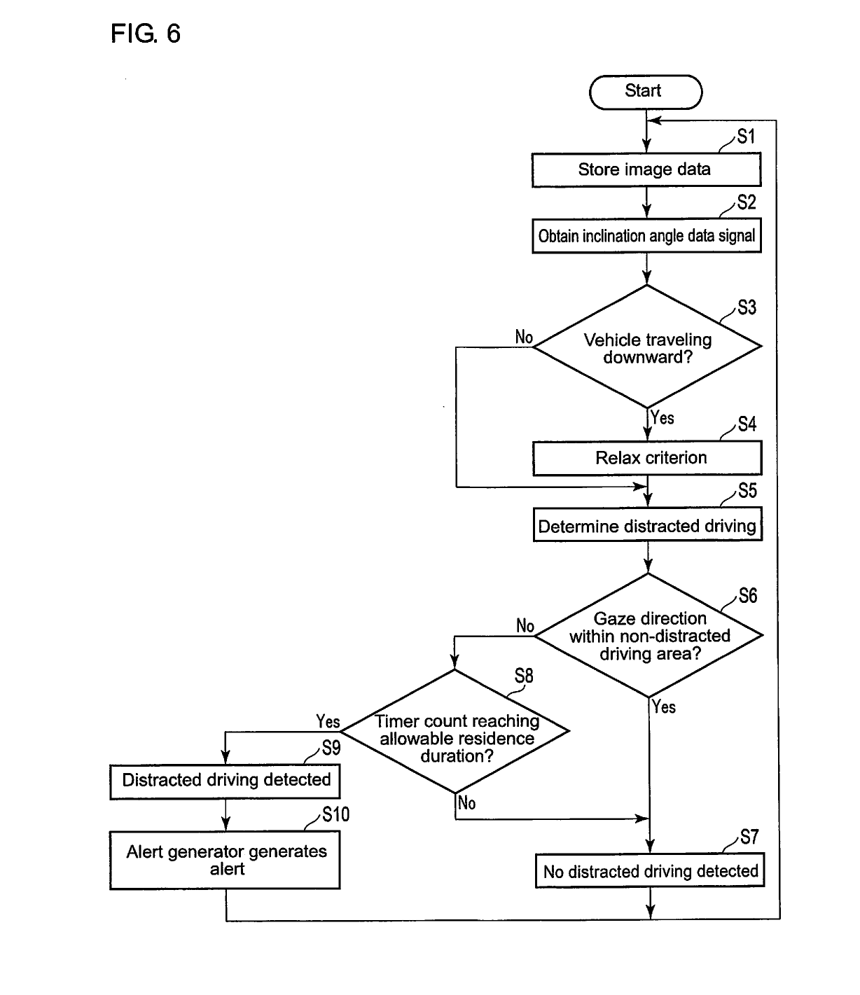

An example operation of the distracted driving determination apparatus 10 with the above structure according to the present embodiment performed when the vehicle 1 is traveling on the road 60 from left to right in FIG. 4 will now be described with reference to the flowchart in FIG. 6.

FIG. 6 is a flowchart showing an example operation performed by the distracted driving determination apparatus 10 according the present embodiment.

While the vehicle 1 is traveling on the road 60, the driver camera 5 captures images of the driver 50 constantly or in response to requests from the distracted driving determination apparatus 10, and outputs image data signals a to the distracted driving determination apparatus 10.

Each image data signal a output from the driver camera 5 is output through the input/output interface unit 20 to the image data obtaining unit 31. In response to the received signal, the image data obtaining unit 31 stores the image data A representing the state of the driver 50 into the image data storage 42 (S1).

While the vehicle 1 is traveling on the road 60, the inclination angle sensor 6 measures the inclination angle of the vehicle 1 with respect to the horizontal plane, and outputs the resultant inclination angle data signal b to the distracted driving determination apparatus 10. When, for example, the vehicle 1 on the road 60 shown in FIG. 4 is traveling within the area α parallel to the horizontal plane, the inclination angle sensor 6 outputs the inclination angle data signal b indicating zero to the distracted driving determination apparatus 10. When the vehicle 1 enters the area β including a downward slope from the area α, the inclination angle sensor 6 outputs the inclination angle data signal b indicating a negative value to the distracted driving determination apparatus 10.

The inclination angle data signal b output from the inclination angle sensor 6 is received by the input/output interface unit 20, and then output from the input/output interface unit 20 to the traveling state obtaining unit 32. The traveling state obtaining unit 32 then outputs the inclination angle data signal b to the traveling state determiner 33 (S2).

Although step S2 follows step S1 in FIG. 6 for ease of explanation, step S1 and step S2 are actually performed constantly in parallel.

When receiving the inclination angle data signal b indicating a negative value, the traveling state determiner 33 determines that the vehicle 1 is traveling downward, thus outputting the determination result signal D1 to the criterion changer 34. When receiving the inclination angle data signal b indicating a positive value, the traveling state determiner 33 determines that the vehicle 1 is traveling upward, thus outputting the determination result signal D2 to the criterion changer 34. When receiving the inclination angle data signal b indicating zero, the traveling state determiner 33 determines that the vehicle 1 is traveling along the horizontal plane, thus outputting the determination result signal D3 to the criterion changer 34. The distracted driving determination apparatus 10 according to the present embodiment may not output the determination result signals D2 and D3.

When the vehicle 1 is determined to be traveling downward, and the determination result signal D1 is output to the criterion changer 34 (Yes in S3), the criterion changer 34 updates the determination criterion E, which is stored in the criterion storage 44, by relaxing the determination criterion E (S4).

The determination criterion E includes the allowable residence duration, which is a duration for which the gaze direction F is allowed to reside within the distracted driving area I, and the position and dimension of the non-distracted driving area G in the vertical direction. When the vehicle 1 is traveling downward, the driver 50 may look forward in the traveling direction beyond the point γ representing the end of the slope as approaching the point γ. The driver 50 then intentionally looks up with respect to the traveling direction for a longer duration. Thus, the criterion changer 34 may relax the determination criterion E by extending the allowable residence duration or enlarging the non-distracted driving area G.

When the vehicle 1 is determined not to be traveling downward (No in S3), the processing advances to step S5 (described later) without changing the determination criterion E stored in the criterion storage 44.

The distracted driving determiner 36 then obtains the image data A from the image data storage 42 and the determination criterion E from the criterion storage 44, and starts determining distracted driving based on the image data A and the determination criterion E (S5).

More specifically, the distracted driving determiner 36 determines whether the gaze direction F, which is obtained from the face orientation or gaze of the driver 50 captured in the image data A, resides within the non-distracted driving area G (S6). When determining that the gaze direction F resides within the non-distracted driving area G (Yes in S6), the distracted driving determiner 36 determines that the driver 50 is not engaging in distracted driving (S7). The processing returns to the processing in step S1.

When determining that the gaze direction F resides within the distracted driving area I (No in S6), the distracted driving determiner 36 activates the built-in timer 36a to measure the duration for which the gaze direction F continuously resides within the distracted driving area I, and determines whether the measured value has reached the allowable residence duration set for the distracted driving area I (S8). When the gaze direction F shifts to another area (e.g., another distracted driving area I or the non-distracted driving area G) before the measured value reaches the allowable residence duration (No in S8), the distracted driving determiner 36 stops the timer 36a, resets the measured value, and detects no distracted driving (S7). The processing returns to the processing in step S1.

When the measured value by the timer 36a has reached the allowable residence duration in step S8 (Yes in S8), the distracted driving determiner 36 detects distracted driving, and outputs the determination signal k to the alert controller 38 (S9).

When receiving the determination signal k, the alert controller 38 outputs the instruction signal c through the input/output interface unit 20 to the alert generator 7. In response to the instruction signal c, the alert generator 7 generates an alert (S10). This alerts the driver 50. The processing then returns to the processing in step S1.

### Advantages and Effects

As described above, the distracted driving determination apparatus 10 according to the present embodiment can relax the determination criterion E to reflect specific situations in which the driver 50 may intentionally look up with respect to the traveling direction for a longer duration when the vehicle 1 is traveling downward.

Such relaxation includes enlarging the non-distracted driving area G upward, extending the allowable residence duration set for the distracted driving area I, or combining these processes.

The relaxed determination criterion E and the image data A for the driver 50 are used to determine distracted driving of the driver 50.

As described above, the determination criterion is changed appropriately to reflect the specific situations of the vehicle 1 traveling downward. This lowers the likelihood that distracted driving is erroneously detected, and thus avoids unintended alerts.

### Second Embodiment

A distracted driving determination apparatus according to a second embodiment will be described in detail below.

### Structure

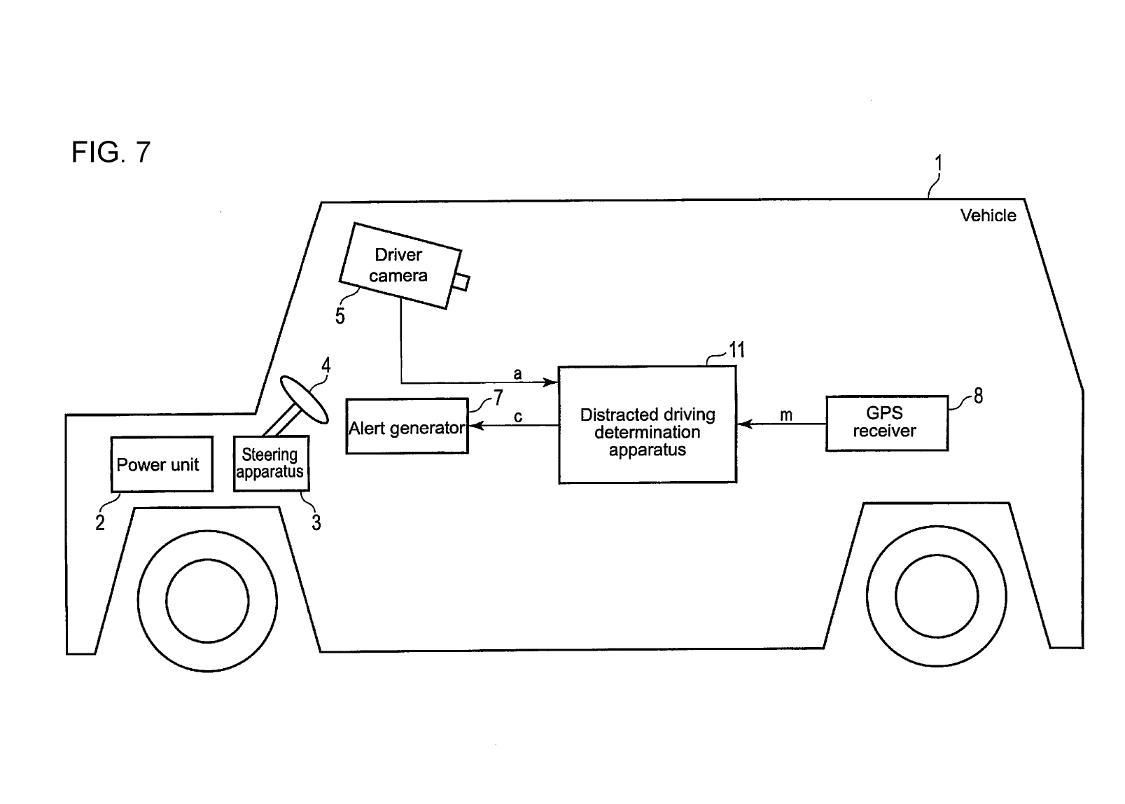

FIG. 7 is a schematic diagram of a vehicle 1 including a distracted driving determination apparatus 11 according to the second embodiment.

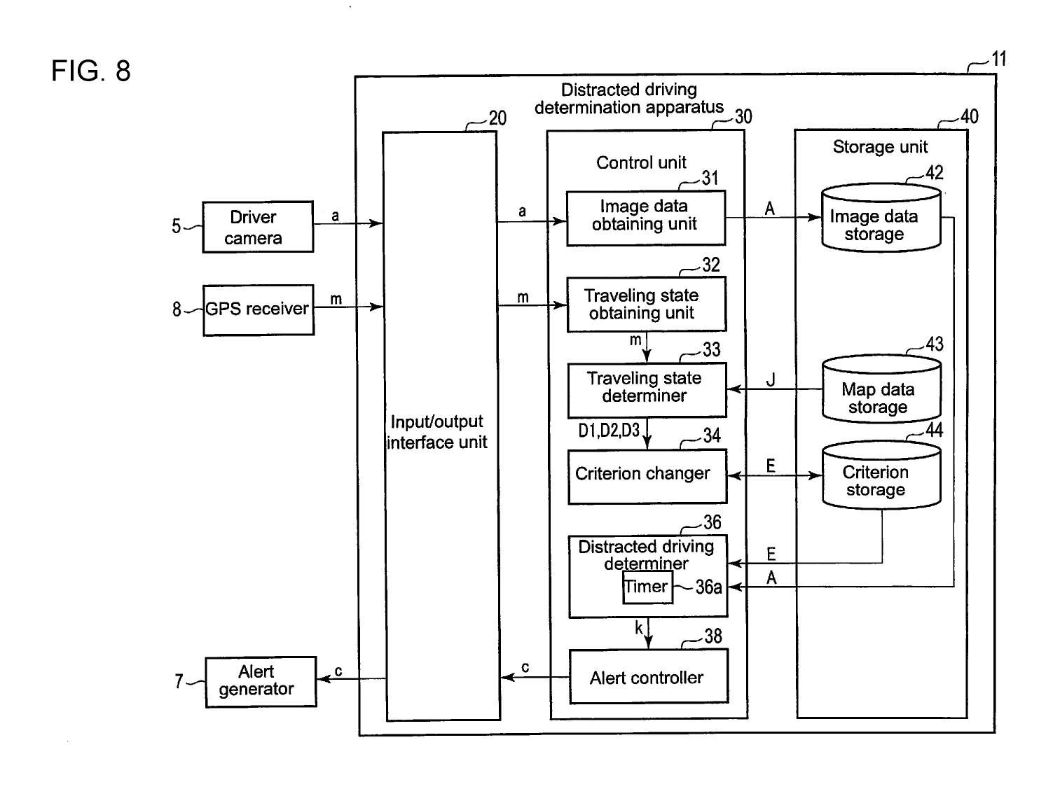

FIG. 8 is a functional block diagram of the distracted driving determination apparatus 11 according to the second embodiment.

The distracted driving determination apparatus 11 according to the second embodiment is a modification of the distracted driving determination apparatus 10 according to the first embodiment. The components of the distracted driving determination apparatus 11 different from the components of the distracted driving determination apparatus 10 will be described below, and the same components as the components of the distracted driving determination apparatus 10 are given the same reference numerals, and will not be described repeatedly.

The structural difference between the vehicle 1 including the distracted driving determination apparatus 10 according to the first embodiment and the vehicle 1 including the distracted driving determination apparatus 11 according to the second embodiment will be described first.

As shown in FIGS. 7 and 1, the vehicle 1 includes the distracted driving determination apparatus 11 according to the present embodiment in place of the distracted driving determination apparatus 10 shown in FIG. 1, and includes a positioning system such as a global positioning system (GPS) receiver 8, in place of the inclination angle sensor 6 shown in FIG. 1.

Further, as shown in FIGS. 8 and 2, the distracted driving determination apparatus 11 includes a map data storage 43 in the storage unit 40, unlike the distracted driving determination apparatus 10.

The GPS receiver 8 receives a traveling location data signal m for the vehicle 1 from the GPS (not shown), and outputs the traveling location data signal m to the input/output interface unit 20.

The input/output interface unit 20 receives the traveling location data signal m output from the GPS receiver 8, and outputs the signal m to the control unit 30.

The map data storage 43 stores map data J including three-dimensional location information for the road 60.

The traveling state obtaining unit 32 receives the traveling location data signal m output from the input/output interface unit 20, and outputs the signal to the traveling state determiner 33.

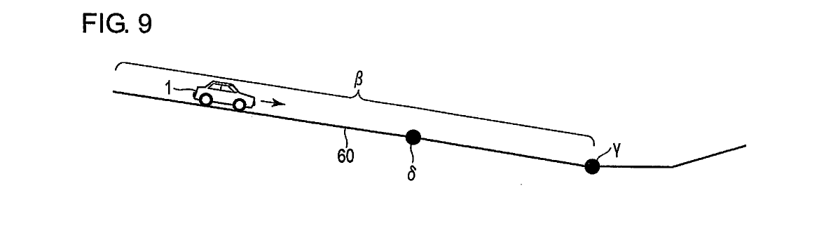

The traveling state determiner 33 obtains the traveling location of the vehicle 1 based on the traveling location data signal m. The traveling state determiner 33 also obtains the map data J from the map data storage 43. The traveling state determiner 33 that has determined that the vehicle 1 is traveling downward based on the traveling location and the map data J outputs the determination result signal D1 to the criterion changer 34 when the traveling location of the vehicle 1 reaches a point δ at a predetermined distance behind the point γ representing the end of the slope as shown in FIG. 9.

The predetermined distance (γ−δ) may have a predetermined constant value. In this manner, the predetermined constant value is used for a long continuous downward slope having a predetermined length or longer to reflect a situation in which the driver 50 at the point δ at a predetermined distance or more behind the point γ representing the end of the slope does not intentionally look in the traveling direction beyond the point γ representing the end of the slope, and is thus unlikely to look up in the traveling direction for a longer duration as described above.

The predetermined distance (γ−δ) may be variable instead of being constant. In this case, the predetermined distance (γ−δ) may be set in accordance with the inclination angle of a downward slope. For example, the predetermined distance (γ−δ) may be set longer as the inclination angle of the downward slope is greater.

As described in the first embodiment, the criterion changer 34 that has received the determination result signal D1 performs the change process that relaxes the determination criterion E stored in the criterion storage 44, and updates the determination criterion E.

### Operation

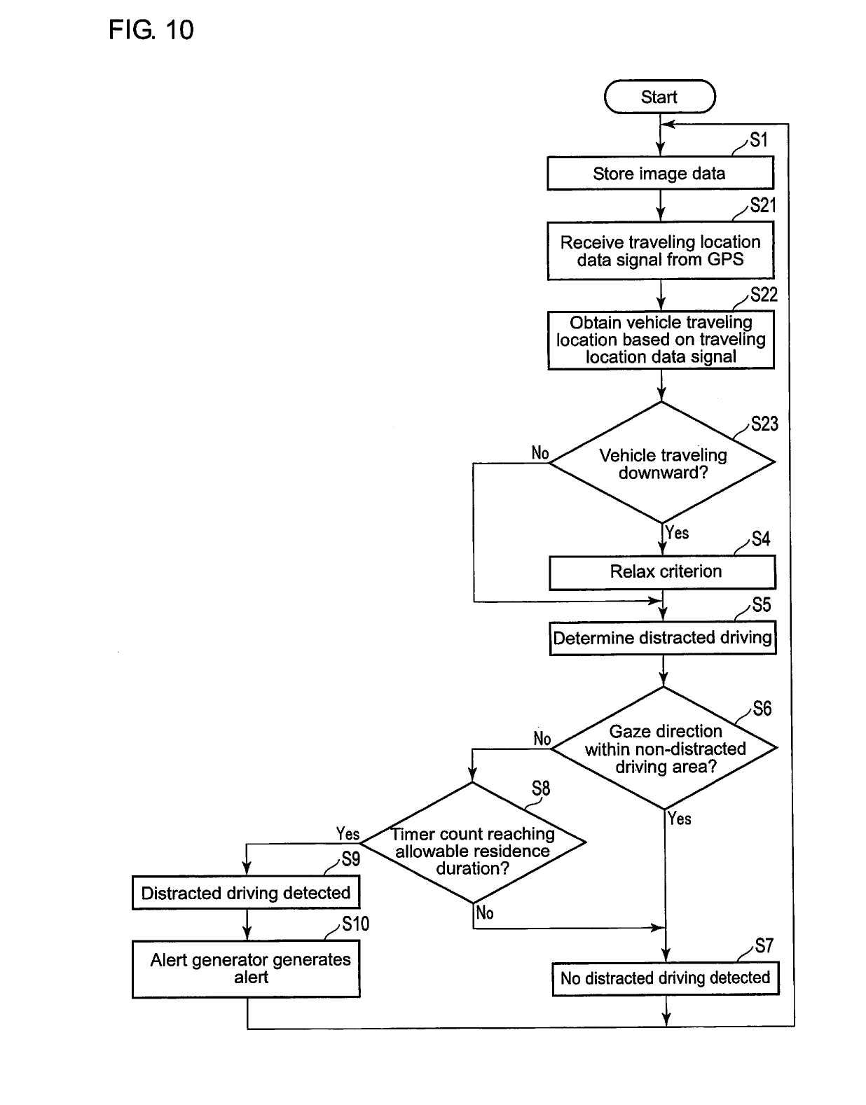

An example operation of the distracted driving determination apparatus 11 with the above structure according to the present embodiment will now be described with reference to the flowchart shown in FIG. 10. The operation is performed when, for example, the vehicle 1 is traveling left to right on the road 60 in FIG. 9 including a downward slope. In the flowchart in FIG. 10, the same steps as the steps in the flowchart in FIG. 6 are given the same step numerals, and will be briefly described below. The steps that are not shown in the flowchart in FIG. 6 will be described in detail.

While the vehicle 1 is traveling on the road 60, the driver camera 5 captures images of the driver 50 constantly or in response to requests from the distracted driving determination apparatus 11, and outputs the image data signal a to the distracted driving determination apparatus 11. The image data signal a is output through the input/output interface unit 20 to the image data obtaining unit 31. In response to the received signal, the image data obtaining unit 31 stores the image data A representing the state of the driver 50 into the image data storage 42 (S1).

While the vehicle 1 is traveling on the road 60, the traveling location data signal m transmitted from the GPS (not shown) is received by the GPS receiver 8. The GPS receiver 8 outputs the signal m to the control unit 30 through the input/output interface unit 20 (S21).

Although step S21 follows step S1 in FIG. 10 for ease of explanation, step S1 and step S21 are actually performed constantly in parallel.

The traveling location data signal m output to the control unit 30 is received by the traveling state obtaining unit 32, and is output to the traveling state determiner 33. The traveling state determiner 33 then obtains the traveling location of the vehicle 1 based on the traveling location data signal m (S22).

The traveling state determiner 33 further obtains the map data J from the map data storage 43. The traveling state determiner 33 then determines whether the vehicle 1 is traveling downward based on the traveling location obtained in step S22 and the map data J (S23).

When the traveling state determiner 33 determines that the vehicle 1 is traveling downward (Yes in S23), and the traveling location of the vehicle 1 obtained in step S22 reaches the point δ at a predetermined distance behind the point γ representing the end of the slope, the determination result signal D1 is output to the criterion changer 34. The processing then advances to the processing in step S4.

When the traveling state determiner 33 does not determine that the vehicle 1 is traveling downward (No in S23), the processing advances to the processing in step S5.

The processing in steps S4 through S10 are the same as in the first embodiment, and will not be described repeatedly.

### Advantages and Effects

As described above, the distracted driving determination apparatus 11 according to the present embodiment includes the GPS receiver 8 in place of the inclination angle sensor 6 to relax the determination criterion E to reflect specific situations in which the driver 50 may intentionally look up with respect to the traveling direction for a longer duration when the vehicle 1 is traveling downward as in the first embodiment. Such relaxation includes enlarging the non-distracted driving area G upward, extending the allowable residence duration set for the distracted driving area I2, or combining these processes.

This lowers the likelihood that distracted driving is erroneously detected as in the first embodiment, and thus avoids unintended alerts.

The distracted driving determination apparatus 11 according to the present embodiment includes the map data storage 43 storing the map data J. The distracted driving determination apparatus 11 according to a modification may include a receiver (not shown) in place of the map data storage 43 to receive the map data J that is externally transmitted through wireless communication and to provide the data to the traveling state determiner 33.

Although the present invention has been described based on the specific embodiments with reference to the appended drawings, the present invention is not limited to the above embodiments. Variations and modifications will occur to those skilled in the art within the spirit and scope of the present invention defined by the claims. Such variations and modifications can fall within the technical scope of the present invention.

The present embodiment may be partially or entirely expressed in, but not limited to, the following forms shown in the appendix below in addition to the claims.

### APPENDIX 1

A distracted driving determination apparatus for determining distracted driving of a driver of a vehicle, comprising a hardware processor configured to

obtain image data about the driver from an imaging unit mounted on the vehicle;

determine distracted driving of the driver based on a face orientation and a gaze of the driver captured in the image data and a determination criterion for detecting distracted driving of the driver;

obtain traveling state data about the vehicle from a traveling state obtaining member mounted on the vehicle;

determine whether the vehicle is traveling downward based on the obtained traveling state data; and

change, when the vehicle is determined to be traveling downward, the determination criterion for an upward face orientation and the gaze of the driver from a value used when the vehicle is determined not to be traveling downward.

### APPENDIX 2

A distracted driving determination method performed by an apparatus for determining distracted driving of a driver of a vehicle, the method comprising:

obtaining, with the apparatus, image data about the driver from an imaging unit mounted on the vehicle;

determining, with the apparatus, distracted driving of the driver based on a face orientation and a gaze of the driver captured in the image data and a determination criterion for detecting distracted driving of the driver;

obtaining, with the apparatus, traveling state data about the vehicle from a traveling state obtaining member mounted on the vehicle;

determining, with the apparatus, whether the vehicle is traveling downward based on the traveling state data; and

changing, with the apparatus, when the vehicle is determined to be traveling downward, the determination criterion for an upward face orientation and the gaze of the driver from a value used when the vehicle is determined not to be traveling downward.

1. A distracted driving determination apparatus for determining distracted driving of a driver of a vehicle, the apparatus comprising:
an image data obtaining unit configured to obtain image data about the driver from an imaging unit mounted on the vehicle;
a distracted driving determiner configured to determine distracted driving of the driver based on a face orientation and a gaze of the driver captured in the image data and a determination criterion for detecting distracted driving of the driver;
a traveling state obtaining unit configured to obtain traveling state data about the vehicle from a traveling state obtaining member mounted on the vehicle;
a traveling state determiner configured to determine whether the vehicle is traveling downward based on the obtained traveling state data; and
a criterion changer configured to change, when the vehicle is determined to be traveling downward, the determination criterion for an upward face orientation and the gaze of the driver from a value used when the vehicle is determined not to be traveling downward.

2. The distracted driving determination apparatus according to claim 1, wherein
the determination criterion includes a position and a dimension of a non-distracted driving area in which a gaze direction of the driver is allowed to reside without causing detection of distracted driving, and an allowable residence duration for which the gaze direction of the driver is allowed to reside within a distracted driving area outside the non-distracted driving area without causing detection of distracted driving.

3. The distracted driving determination apparatus according to claim 2, wherein
the criterion changer changes the determination criterion at least by extending the allowable residence duration or by enlarging the dimension or shifting the position of the non-distracted driving area upward with respect to a traveling direction of the vehicle.

4. The distracted driving determination apparatus according to claim 2, wherein
the determination criterion includes a plurality of the distracted driving areas, and a value of the allowable residence duration for each of the distracted driving areas is set in accordance with closeness to the non-distracted driving area.

5. The distracted driving determination apparatus according to claim 4, wherein
the allowable residence duration is set longer for a distracted driving area closer to the non-distracted driving area among the plurality of distracted driving areas.

6. The distracted driving determination apparatus according to claim 1, wherein
the traveling state obtaining member includes an inclination angle sensor mounted on the vehicle, and
the traveling state data includes inclination angle data about the vehicle obtained by the inclination angle sensor with respect to a horizontal plane.

7. The distracted driving determination apparatus according to claim 1, wherein
the traveling state determiner includes a positioning sensor mounted on the vehicle,
the traveling state data includes traveling location data about the vehicle obtained by the positioning sensor, and
the traveling state determiner determines whether the vehicle is traveling downward based on the traveling location data and map data.

8. The distracted driving determination apparatus according to claim 1, further comprising:
an alert control unit configured to control an alert generator to generate an alert when the distracted driving determiner detects distracted driving.

9. A distracted driving determination method performed by an apparatus for determining distracted driving of a driver of a vehicle, the method comprising:
obtaining, with the apparatus, image data about the driver from an imaging unit mounted on the vehicle;
determining, with the apparatus, distracted driving of the driver based on a face orientation and a gaze of the driver captured in the image data and a determination criterion for detecting distracted driving of the driver;
obtaining, with the apparatus, traveling state data about the vehicle from a traveling state obtaining member mounted on the vehicle;
determining, with the apparatus, whether the vehicle is traveling downward based on the traveling state data; and
changing, with the apparatus, when the vehicle is determined to be traveling downward, the determination criterion for an upward face orientation and the gaze of the driver from a value used when the vehicle is determined not to be traveling downward.

10. A program for determining distracted driving, the program causing a computer to implement processes performed by the units included in the distracted driving determination apparatus according to claim 1.

11. A program for determining distracted driving, the program causing a computer to implement processes performed by the units included in the distracted driving determination apparatus according to claim 2.

12. A program for determining distracted driving, the program causing a computer to implement processes performed by the units included in the distracted driving determination apparatus according to claim 3.

13. A program for determining distracted driving, the program causing a computer to implement processes performed by the units included in the distracted driving determination apparatus according to claim 4.

14. A program for determining distracted driving, the program causing a computer to implement processes performed by the units included in the distracted driving determination apparatus according to claim 5.

15. A program for determining distracted driving, the program causing a computer to implement processes performed by the units included in the distracted driving determination apparatus according to claim 6.

16. A program for determining distracted driving, the program causing a computer to implement processes performed by the units included in the distracted driving determination apparatus according to claim 7.

17. A program for determining distracted driving, the program causing a computer to implement processes performed by the units included in the distracted driving determination apparatus according to claim 8.
